(19) United States
(12) Patent Application Publication
(10) Pub. No.: US 2025/0089149 A1
(43) Pub. Date: Mar. 13, 2025

(54) Pre-heating of the filament of an xray tube

(71) Applicant: Spellman High-Voltage Electronics Corporation, Hauppauge, NY (US)

(72) Inventors: Raymond BOWKER, Manorville, NY (US); Nelson REYES, Patchoge, NY (US); William BRASCH, Nesconset, NY (US); Barry SCHNEIDER, Port Washington, NY (US)

(21) Appl. No.: 18/885,241

(22) Filed: Sep. 13, 2024

Related U.S. Application Data
(60) Provisional application No. 63/538,230, filed on Sep. 13, 2023.

(51) Int. Cl. H05G 1/34

(52) U.S. Cl. CPC H05G 1/34

(57) ABSTRACT

An apparatus includes an Xray tube that has a filament serving as a cathode and an anode. The apparatus is configured to perform a method of driving the filament that includes pre-heating the filament by flowing a current through the filament before a high-voltage is applied between the filament and the anode. The method includes increasing an effective value of the current and the high-voltage, preferably by stepping the effective value of the current and the high-voltage essentially simultaneously. The method includes emitting Xrays in response to increasing the effective value of the current through the filament and the high-voltage.

### CROSS-REFERENCE TO RELATED APPLICATIONS

None.

### FIELD OF THE INVENTION

This disclosure relates generally to thermionic-emission Xray tubes, in particular, to the pre-heating of the filament of thermionic-emission Xray tubes.

### BACKGROUND OF THE INVENTION

FIG. 1 illustrates a typical thermionic-emission Xray tube. In use, a voltage Un is regulated to flow a constant current I₀ through a filament C of the Xray tube, thus causing the heating of the filament C, which plays the role of a cathode. In order to emit Xrays, a high voltage Uₐ is applied between the filament C and a metallic target A, which plays the role of an anode. Electrons emitted by the filament C are accelerated in a vacuum tube by the electric field caused by the high voltage Uₐ and collide with the metallic target A. The collision produces Xrays.

FIG. 2 illustrates typical calibration curves of an Xray tube. Each calibration curve corresponding to a value of the high voltage Uₐ (either 40 kV, 50 kV, 60 kV, 70 kV, 100 kV, 125 kV, or 150 kV, as shown in this example) is measured by flowing a constant current I₀ (plotted on the x-axis) through the filament and measuring the tube emission current |I₀-I₁| (plotted on the y-axis) after quasi-steady-state has been reached. A filament calibration table is then created that provides, for selected values of the high-voltage Uₐ and target values of the tube emission current |I₀-I₁|, the corresponding filament current I₀ that will generate the target values of the tube emission current |I₀-I₁| under the high-voltage Uₐ, which is proportional to the amount of Xrays emitted by the tube and directed to a patient or object.

FIG. 3 illustrates a typical time response of an Xray tube. The filament current (A) is maintained at standby value until a time Prep at which the filament is pre-heated by increasing the flow of current to I₀ provided by the calibration table. When Xray emission is desired, the high-voltage Uₐ is turned on. When Xray emission is no longer desired, the high-voltage Uₐ is turned off. The filament current (A) may be returned to the standby value right away (as shown) or after a delay, for example, on the order of 1000 ms. The typical response of the Xray tube shown in FIG. 3 indicates that the tube emission current |I₀-I₁| peaks just after the high voltage Uₐ is turned on and then reaches the quasi-steady-state value (i.e., the target value) used in the calibration table. The inventors have discovered that the reason for this peak is that the filament heats up at the beginning of the electronic emission until it reaches a steady state temperature.

In view of the foregoing, there is a general need in the art for apparatus and method for achieving a more accurate (i.e., closer to a target value of tube emission current), stable or constant tube emission current when the high voltage Uₐ is turned on. In particular, the more accurate, stable or constant tube emission current is preferably in a way that does not cause emission delays.

### SUMMARY

The disclosure describes an apparatus and a method for achieving a more accurate, stable or constant tube emission current in thermionic-emission Xray tubes. The more accurate, stable or constant tube emission current relies on a modification of the pre-heating of the filament of the thermionic-emission Xray tubes before the high voltage Uₐ is turned on relative to the heating of the filament while the high voltage Uₐ is turned on (i.e., while the filament is emitting). In particular, the filament is pre-heated before the high voltage Uₐ is turned on by flowing a current having a selected first effective value that generates an initial temperature in the filament. The first effective value may be selected lower than a second effective value (e.g., a target filament current) by an amount that reduces the initial surge or overshoot of the emission current initially anticipated when the high voltage Uₐ is turned on. The pre-heating duration may be constant and is sufficiently long to achieve an essentially steady-state temperature in the filament. When the high voltage Uₐ is turned on, the current flown through the filament is increased (e.g., stepped to the second effective value that is higher. The inventors have discovered that the thermal response caused by the combination of the increase in current and by the turning on of the high voltage Uₐ can essentially be a stable or constant temperature of the filament, which translates into a more accurate (i.e., closer to a target value of tube emission current), stable or constant tube emission current.

Thus, this approach may eliminate the undesirable overshoot behavior of the tube emission current |I₀-I₁| observed in FIG. 3, and more generally the undesirable behaviors (e.g., such as undershoot behaviors). The reduction or elimination of undesirable behaviors of the tube emission current |I₀-I₁| may enable Xray radiations without unnecessary delays and having a shorter pulse that is more accurate, stable, or constant. By virtue of delivering a more accurate, stable, or constant radiation pulse, this approach can further reduce or eliminate the risk of the target of the radiations (e.g., a patient or an object) receiving unnecessary or excessive radiation.

Further, by virtue of delivering a more accurate, stable, or constant radiation pulse, this approach may improve Xray tube reliability and life.

In one embodiment, the current flown in the filament during the pre-heating is constant (i.e., its value is the first effective value).

In one embodiment, the current flown in the filament during the pre-heating is pulse-width-modulated or amplitude-modulated (i.e., a weighted average between the low and high pulse values as determined by the duration of the pulse or the amplitude of the pulse, is the first effective value).

Preferably, the current flown in the filament during the emission is a constant current (i.e., its value is the second effective value).

Preferably, when or after the high voltage Uₐ is turned off, the current flowing in the filament is first lowered to the first effective value so that the filament reaches the proper pre-heating temperature for a successive turning on of the high voltage Uₐ. In the absence of a successive turning on of the high voltage Uₐ for a duration that is longer than the pre-heating duration, the current may then be lowered to the lowest standby value.

### BRIEF DESCRIPTION OF THE DRAWINGS

For a more detailed description of the embodiments of the disclosure, reference will now be made to the accompanying drawings, wherein:

FIG. 1 is a schematic illustrating a thermionic-emission Xray tube;

FIG. 2 is a graph illustrating several calibration curves of an X-ray tube, each obtained for a different value of the high voltage between the cathode and the anode;

FIG. 3 is a graph illustrating an example of a traditional case of an Xray tube pre-heating process without the use of the invention, showing a measured filament current as a function of time and a tube emission current as a function of time, both obtained when the filament is pre-heated with a current having the same value as the value during the filament emission (when the high voltage between the cathode and the anode is turned on);

FIG. 4 is a flow chart of a method for determining the first effective value of the current during pre-heating of the filament, expressed as a percentage of the second effective value of the current during emission of the filament, that can be used for achieving a more accurate, stable or constant tube emission current;

FIG. 5 is a graph of the percentage determined by the method shown in FIG. 4 as a function of the tube emission current |I₀-I₁| obtained in quasi-steady-state conditions;

FIG. 6 is a schematic of a close control loop for driving a filament;

FIG. 7 is a flow chart of a method for driving a filament during pre-heating and emission phases;

FIG. 8 is a graph illustrating a filament current as a function of time and a tube emission current as a function of time measured when the method in FIG. 6 is used; and

FIG. 9 is a graph illustrating a filament current as a function of time and a tube emission current as a function of time measured when the current flown in the filament during the pre-heating is pulse-width-modulated.

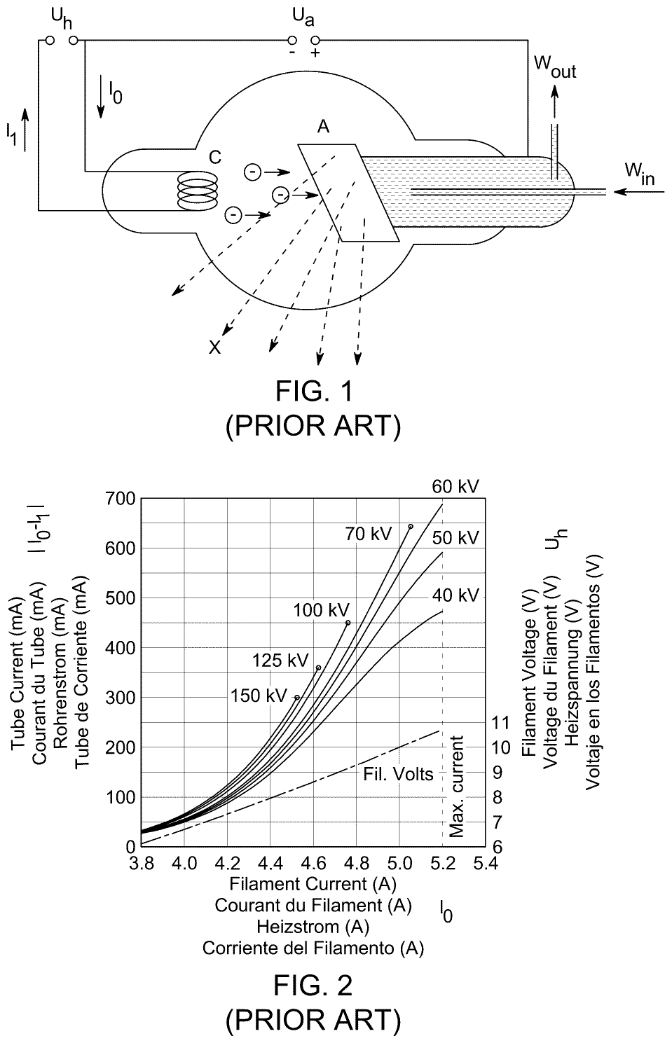

### DETAILED DESCRIPTION

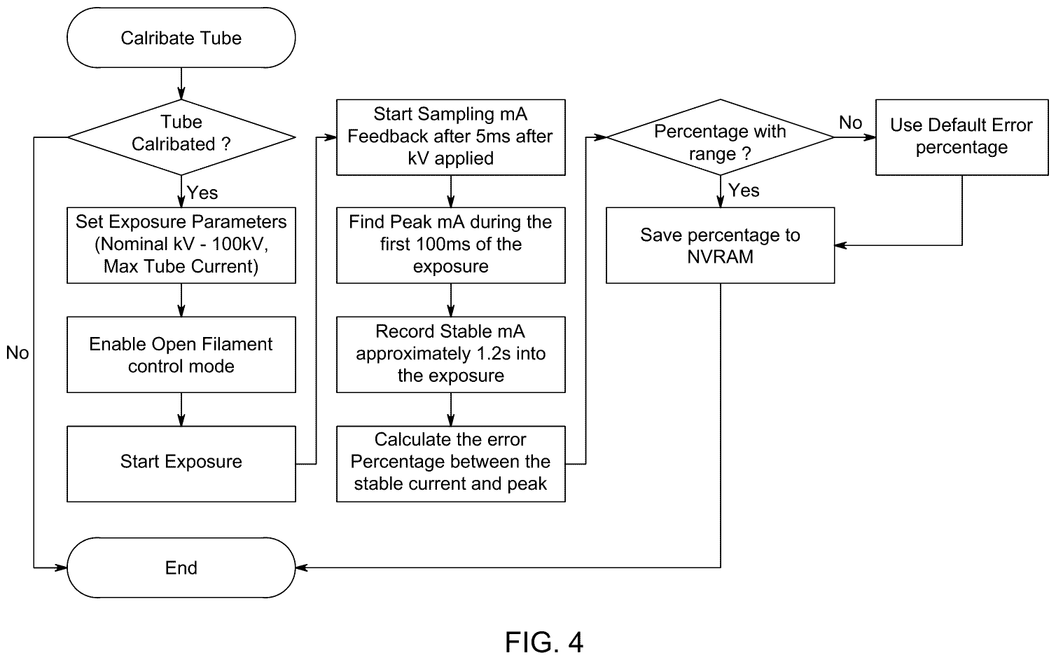

In the method of FIG. 4, the nominal high-voltage value Uₐ of 100 kV is used to determine the first effective value of the current during pre-heating of the filament, expressed as a percentage of the second effective value of the current during emission of the filament. However, in general, the method can be repeated for any applicable high-voltage value. After the nominal high-voltage value Uₐ of 100 kV was used, it was measured that the percentages calculated by the method are at least valid for any high voltage range between 80 kV and 120 kV.

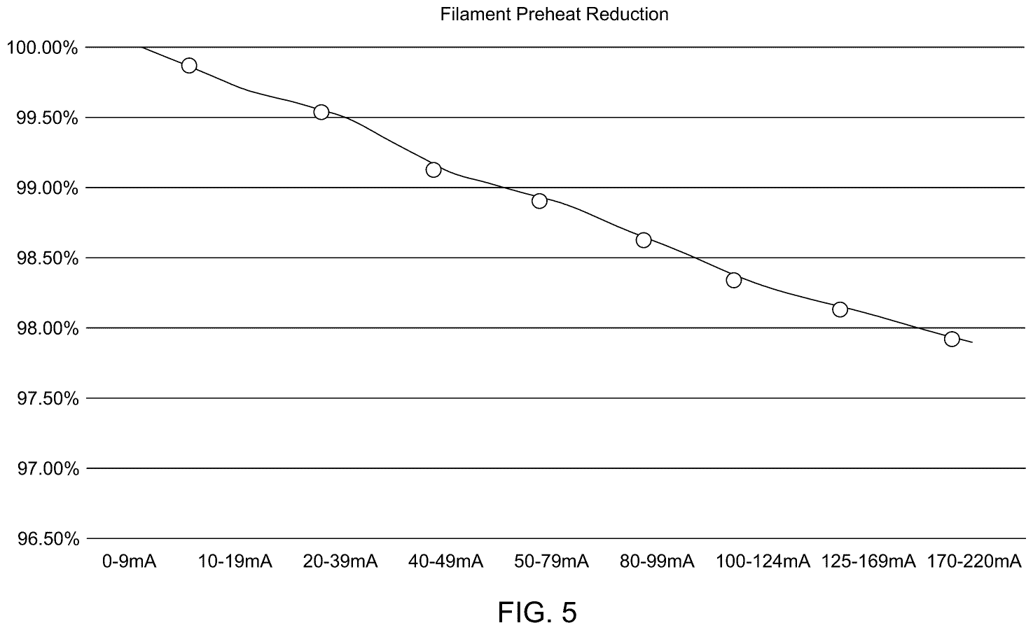

In the method of FIG. 4, the maximum tube current (which is achieved with the maximum filament current I₀) is used during the pre-heating of and the emission by the filament to compute one percentage. However, in general, the method can be repeated for any applicable tube emission current value, as is shown, for example, in FIG. 5. After the measurement with the maximum tube current is performed, the other percentages corresponding to other tube current values can be calculated by linear extrapolation. As is shown in FIG. 5, it was measured that linear extrapolation can lead to accurate calculations to compute the percentages at the other tube current values.

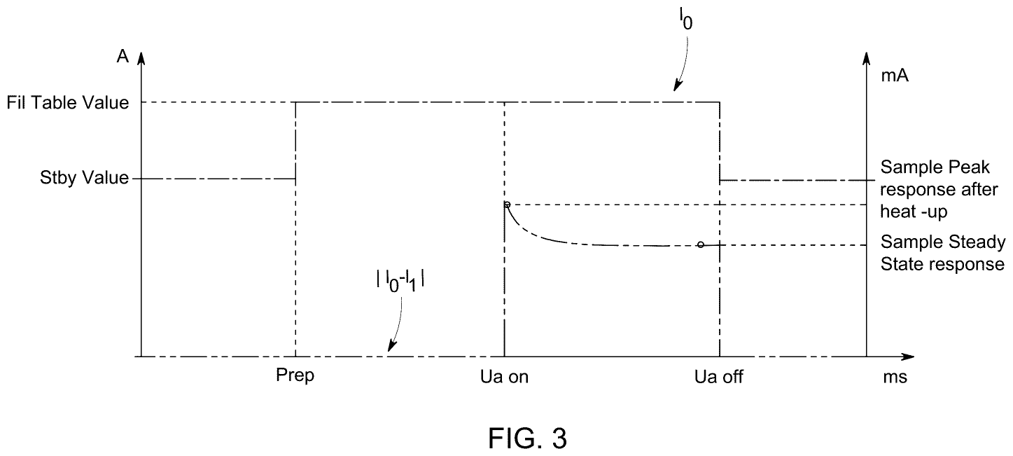

An illustration of the measurements of the “Peak mA” and “Stable mA” as performed in the method of FIG. 4 are shown in FIG. 3 by the two “Sample” values on the curve of the tube emission current as a function of time.

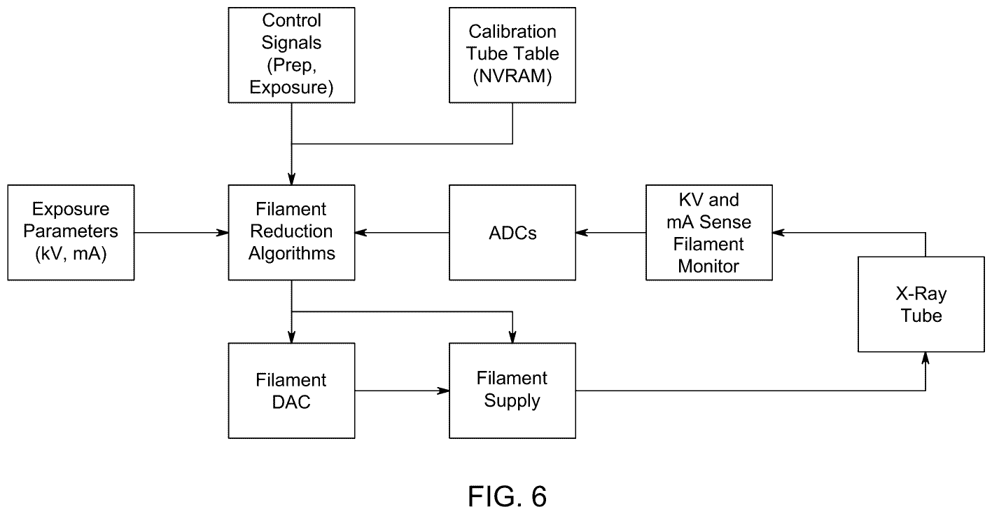

FIGS. 6 to 8 illustrate the driving of a filament in accordance with one embodiment of the invention. A user sets the exposure parameters in terms of the nominal high-voltage value Uₐ in kV and the desired tube emission current |I₀-I₁| in mA. The calibration table has several columns, each corresponding to one high-voltage value Uₐ, and several lines, each corresponding to one target value of the tube emission current |I₀-I₁|, and lists the values of the filament current I₀ that needs to be used to achieve these conditions in quasi-steady-state (see FIG. 2 for a graphical representation of the calibration table). The table NVRAM has at least one column and several lines, each corresponding to one target value of the tube emission current |I₀-I₁|, and lists the reduction percentage of the current to be used during the pre-heating phase to avoid overshooting. The filament current to be used during the pre-heating phase is calculated with the value of the filament current I₀ retrieved from the calibration table and the reduction percentage retrieved from the table NVRAM. The current in the filament is driven to the prescribed curve as a function of time that is shown in the top curve of FIG. 8 (i.e., a stepped curve).

Preferably, the faster the tube emission current achieves quasi-steady-state (or more generally accuracy), the better. In some applications, especially medical applications, quasi-steady-state is expected to be attained in a few micro-seconds. Therefore, the increase of the filament current I₀ and the high-voltage Uₐ should be timed to achieve quasi-steady-state within that time interval. For example, if stepped increases are used for the filament current I₀ and the high-voltage Uₐ, these increases may preferably occur essentially simultaneously.

Comparing FIGS. 3 and 8, it can be seen that by using a suitable current step when transitioning from the pre-heating phase to the emission phase, the tube emission current |I₀-I₁| is more accurate, stable or constant than without using a current step (i.e., using a constant current).

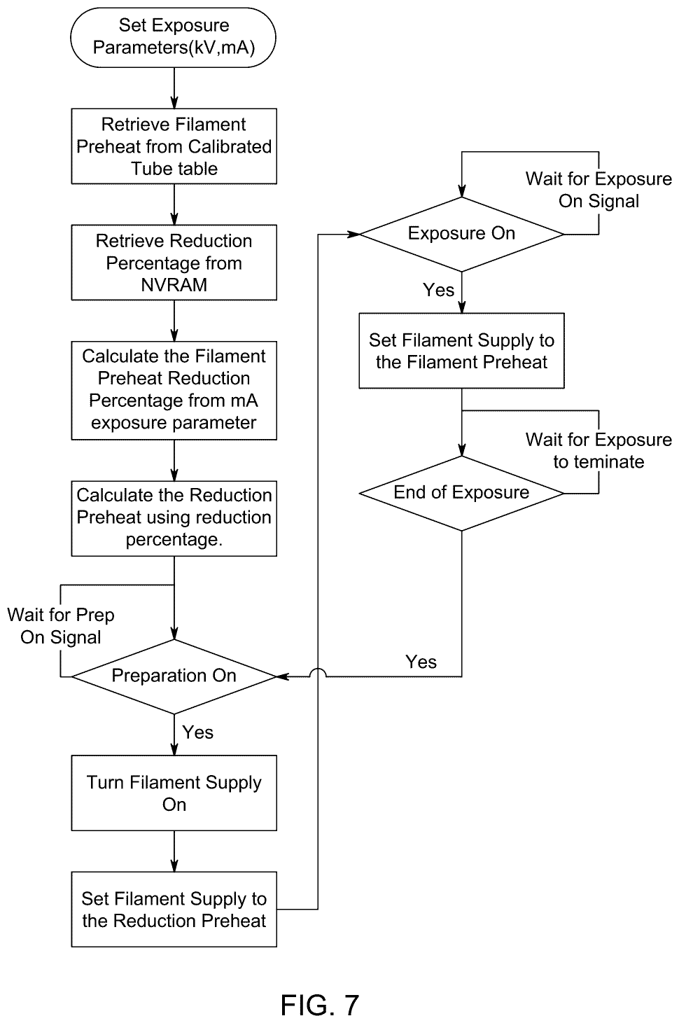

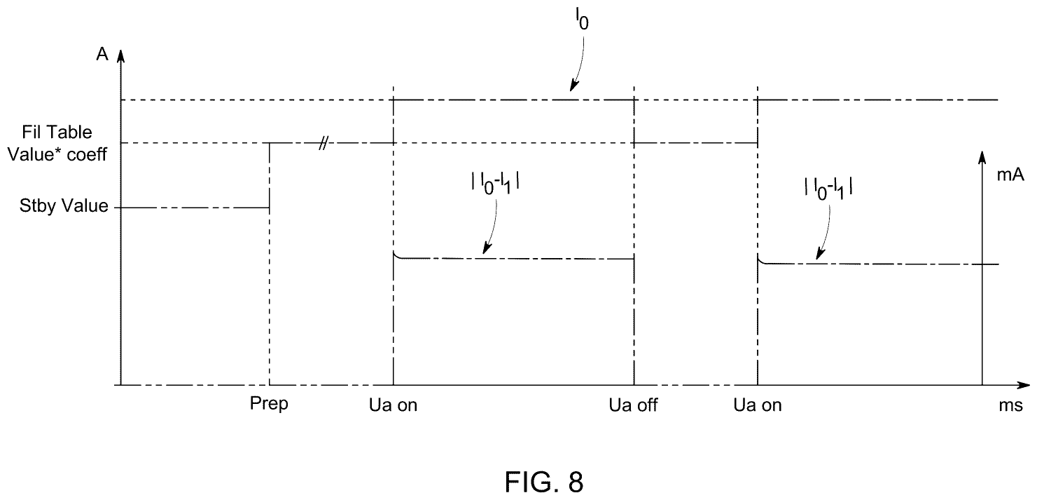

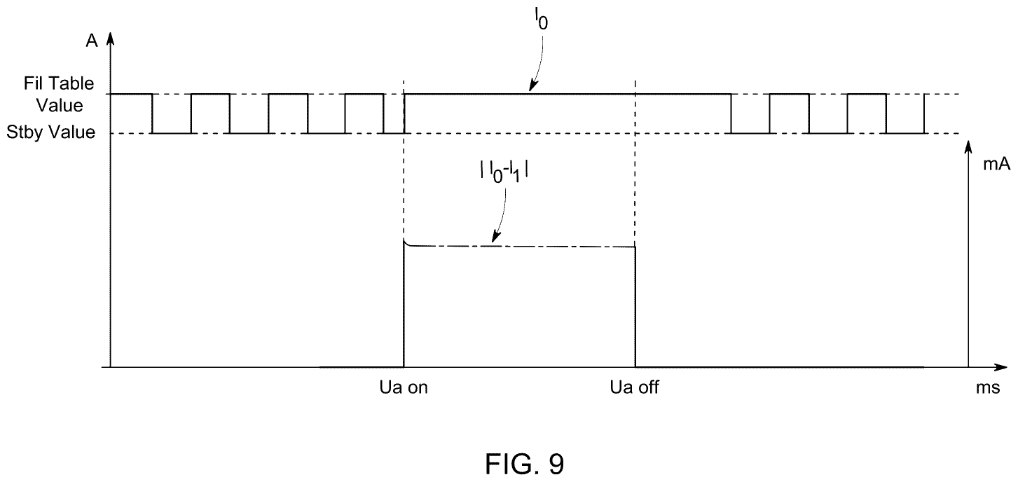

FIG. 9 illustrates that the reduction percentage of the filament current I₀ during the pre-heating phase can alternatively be achieved using pulse-width or amplitude modulation, for example, a modulation between the standby current value and the value of the filament current I₀ retrieved from the calibration table. Therefore, the effective value of the filament current during pre-heating of the filament (i.e., a weighted average between the low and high current pulse values) is the quantity that determines the response of the filament. As such, in the method shown in FIG. 7, the step of “setting the filament supply to the heat reduction” is not limited to applying a constant current having a lower value.

While the description discloses specific values of the high-voltage (Uₐ), the tube emission current (|I₀-I₁|), and the filament current (I₀), other values may be used, depending on the Xray tube used, the energy of the Xrays, and the apparatus used to power the Xray tube.

While the description discloses specific percentages of the second effective value of the current during emission of the filament to compute the first effective value of the current during pre-heating of the filament, other values may be used, for example, values determined experimentally by the method shown in FIG. 4. However, it should be noted that the invention is not limited to using values obtained with the method shown in FIG. 4. Also, the invention is not limited to expressing the first effective value of the current during pre-heating of the filament as a percentage of the second effective value of the current during emission.

1. A method of driving a filament of an Xray tube having a filament serving as a cathode and an anode, comprising:
pre-heating the filament by flowing a current through the filament before a high-voltage is applied between the filament and the anode;
increasing an effective value of the current and the high-voltage; and
emitting Xrays in response to increasing the effective value of the current through the filament and the high-voltage.

2. The method of claim 1, wherein increasing the effective value of the current and the high-voltage comprises stepping the effective value of the current and the high-voltage essentially simultaneously.

3. (canceled)

4. An apparatus configured to perform the method of claim 1.

5. The apparatus of claim 4, configured to perform the method of claim 2.
